(19) United States
(12) Patent Application Publication
(10) Pub. No.: US 2024/0091821 A1
(43) Pub. Date: Mar. 21, 2024

(54) AUTONOMOUS AND SEMI-AUTONOMOUS HYDROBLASTING SYSTEMS AND METHODS

(71) Applicant: VAUGHN RANDALL ARNOLD, III, WEST PALM BEACH, FL (US)

(72) Inventor: VAUGHN RANDALL ARNOLD, III, WEST PALM BEACH, FL (US)

(21) Appl. No.: 17/957,900

(22) Filed: Sep. 30, 2022

Related U.S. Application Data
(63) Continuation-in-part of application No. 16/817,154, filed on Mar. 12, 2020, now abandoned.
(60) Provisional application No. 62/817,126, filed on Mar. 12, 2019.
(60) Provisional application No. 62/971,289, filed on Feb. 7, 2020.

(51) Int. Cl. B08B 3/02; B24C 3/06; B24C 3/32

(52) U.S. Cl. CPC B08B 3/024; B24C 3/062; B24C 3/32; B08B 2203/0211

(57) ABSTRACT

The present invention is directed to a hydroblasting system comprising a head assembly connected with some conveyance, whether now known or hereafter developed. Such head assembly may comprise, for instance, biasing elements configured to provide such head assembly with a floating functionality stemming from, for instance, the creation of an independent suspension, thereby enabling such head assembly to traverse irregular topographies. Further embodiments of such a head assembly may be configured to enable the same to be used on work surfaces such as a ceiling or wall, via a pneumatic assembly configured to apply force to such head assembly. Such a head assembly may further comprise a rotating manifold configured to supply the applicator thereof with high pressure fluid, during angular misalignment between the fluid source and the applicator. Further embodiments may use sensors and computing systems to allow for the autonomous movement of such head assembly and/or conveyance.

### CLAIM OF PRIORITY

The present application is a continuation-in-part patent application which claims priority to a previously filed and currently pending non-provisional patent application having Ser. No. 16/817,154 and a filing date of Mar. 12, 2020, which itself claims priority pursuant to 35 U.S.C. § 119(e) to a currently pending and prior filed provisional application having Ser. No. 62/817,126, filed on Mar. 12, 2019, as well as to a currently pending and prior filed provisional application having Ser. No. 62/971,289, filed on Feb. 7, 2020, the contents of each of which are hereby incorporated herein, by reference, in their entireties.

### FIELD OF THE INVENTION

The present invention is directed to hydroblasting systems configured to apply high-pressure fluid to a work surface, for cleaning and destructive purposes, and may comprise a head assembly capable of traversing irregular topography. The novel structural components disclosed herein may also be utilized to create autonomous and semi-autonomous hydroblasting systems.

### DESCRIPTION OF THE RELATED ART

Hydroblasting and/or waterblasting are terms generally used to refer to the process of cleaning, treating, or otherwise preparing a given surface through the application of high-pressure water thereon. Generally speaking, the process of hydroblasting, and thus the efficacy thereof, relies entirely on the energy of water striking a surface. As a result, the flow rate and/or pressure of the water dictates the degree to which a given surface may be cleaned, treated, or prepared. Indeed, application of a sufficient amount of fluid pressure can result in the demolition of a surface.

Typically, due to the intense fluid pressures applied to a given surface during hydroblasting processes, hydroblasting apparatuses commonly consist of large machines capable of applying the pressurized water to a large surface area. Yet, due to the bulkiness of such machines, as well as the need for the component applying the pressurized water to the work surface to remain at a substantially constant distance therefrom to remain effective, such apparatuses typically are only useful in the context of large, flat, or uncomplicated surfaces. Likewise, due to the weight and difficulty in maneuvering such large apparatuses, such large apparatuses are commonly reserved for floors and other similarly situated surfaces that can support the weight of the same.

As a result, when other surfaces such as walls or ceilings are hydroblasted, an operator typically resorts to the use of handheld hydroblasting attachments such as guns or wands. While the use of such attachments allows the operator to apply pressurized water to specific locations, without regard for the complicated topography of a surface, these attachments are largely inefficient, as they can only be applied to a comparatively smaller area per second than the aforementioned large hydroblasting apparatuses.

Because of the lower cleaning rate, these attachments are also more susceptible to human error, whether through misapplication or omission. An operator using an attachment must provide a greater level of manual control compared to the large floor units. Therefore, the operator may accidentally apply the pressurized water to an inappropriate area, such as a surface not intended for cleaning, another person, or even himself. Likewise, an operator may miss a portion of the surface intended to be hydroblasted. As a result, hydroblasting attachments are disfavored by operators, as such devices are inefficient and can present safety hazards.

In light of the foregoing, there exists a need in the art wherein a hydroblasting apparatus, such as the aforementioned large floor machines, is constructed so as to be applied to any surface, whether comprising a floor, a wall, a ceiling, or any other surface comprising a complicated, or irregular topography. In so doing, the need for reliance on hydroblasting attachments may be effectively reduced, thereby increasing efficiency and safety for those operating such machines.

More specifically, such a device should be devised so as to enable the same to be applied over the topography of any surface, whether irregular or otherwise, whilst being positionable and movable on any type of conveyance, whether now known or hereafter developed. In conjunction therewith, such a device should be designed to easily be applied to any work surface, such that the device may maintain constant contact with the work surface throughout the treatment thereof. Further, such a device should be configured to enable the entirety of a work surface over which the device is disposed to be treated without the need for adjusting the location of such device, such as through the oscillatory motion of the fluid application components. Additionally, such a device should be further configured to enable the remote and/or autonomous operation thereof, such as through the interconnection of sensors disposed on the device, and the positioning of extrinsic components configured to relay positioning information to such device.

### SUMMARY OF THE INVENTION

One primary goal of the present invention is to implement a large hydroblasting head assembly, of the type typically reserved only for floor use due to its size and weight, on any conveyance such that the head assembly may be utilized on virtually any surface, including walls and ceilings, regardless of the orientation or topography of the surface. While exemplary mechanical and structural features of the invention are disclosed below, it will first be helpful to discuss the invention from a systems level perspective in order to understand how it may be used and how it may provide autonomous and semi-autonomous control.

In a primary embodiment a head assembly of the present invention is attached to a conveyance of any type, which may include a man lift, a track hoe, a scissor lift, a boom, a scaffolding or some other frame and/or track system, a wheeled cart, or any other conveyance whether now known or hereafter developed. The head assembly may be attached to the conveyance via an articulated or floating coupling which can accommodate the head unit in a variety of angles relative to the conveyance and can hold the head unit at a predetermine distance from the wall, even as the high-pressure water stream pushes back on the head unit.

In a preferred embodiment, the conveyance is mechanized and can propel and articulate itself through mechanical, electromechanical, hydraulic, pneumatic, or some other means. An operator may then control the conveyance to position and move the head assembly on the work surface. In one example, the head unit may be attached to the boom of a man lift and the operator may move the boom or drive the man lift as necessary to position the head assembly relative to the work surface.

Continuing with the example of the man lift, though appreciating that the principles discussed may be implemented on virtually any type of conveyance, a computerized control system may be implemented to facilitate the use of the conveyance-borne head assembly. Given that many types of conveyances have computerized drive systems themselves it will be appreciated that electronic or digital inputs may be sent to the computerized drive system. As such, the present invention includes a computerized control system that interfaces directly with the computerized drive system of the conveyance. In a preferred embodiment, the interface and inputs to the computerized control system are optimized to facilitate placement of the head assembly, and it will be appreciated that such an interface and/or inputs may differ from the regular interface and/or inputs on the conveyance.

By way of non-limiting example, if the operator enters an input to move the head assembly vertically up a wall, then the computerized control system may generate and send signals to the conveyance sufficient to, simultaneously, increase the boom angle, extend the boom, and/or move the man lift closer to the wall, all in varying amounts, in order to optimize the placement and contact angle of the head assembly against the wall. Additionally, the computerized control system can also be programmed to recognized hard limits in order to avoid mishaps. For example, a maximum boom radius may be established to correspond with the maximum articulation angle of the head unit in order to ensure that the head unit remains orthogonal to the work surface. The computerized control system can be programmed with a hard stop if an operator tries to exceed this maximum boom radius. Alternatively, the computerized control system can be programmed to move the conveyance in order to avoid extending the boom past the maximum boom radius. Additionally, maximum boom angles can be established in order to ensure that the conveyance remains stable. As such, a level of semi-autonomous control is realized. In alternative embodiments, boundary control elements can be combined with sensors on the head assembly and/or conveyance to establish boundary lines past which the head assembly or conveyor may not be moved. By way of example, the boundary control elements can be configured to emit infrared or ultrasonic signals detectable by the sensors. GPS control may also be implemented to establish a geo-fence for the conveyance.

A more autonomous system may also be realized as part of the present invention by programming a set of instructions into the computerized control system that corresponds with the paths to be followed by the head assembly. The instructions can be executed and the computerized control system will autonomously move the head assembly through the programmed paths, and will autonomously adjust the various parameters of the conveyance as necessary. By way of example, a head assembly attached to a scissor lift can be programmed with rudimentary X-Y coordinates to step through when cleaning a section of wall that has no complicated topography. Assuming that the scissor lift is positioned at a predetermined distance from the wall and is positioned to travel perpendicular to the wall, the travel of the scissor lift can be represented by X coordinates, while the extension of the scissor lift can be represented with Y coordinates. Therefore, the control system can be programmed to move the head assembly across the work surface by reference to simple X and Y coordinate paths and boundaries. For example, the control system can be programmed to first move the head assembly in a positive Y direction (correlating to up the wall) a predetermined amount. Upon reaching the extreme, the control system is further programmed to move the conveyance in a positive X direction by a predetermined distance (correlating to the width of the head unit, plus or minus some overlap) before moving the head assembly in a negative Y direction. The process repeats until the conveyance reaches the final X coordinate. It will be appreciated that by utilizing a conveyance with more points of articulation, such as a man lift, more complicated topographies can be addressed in an autonomous manner, such as ship hulls, tank interiors, ceilings, and the like.

For certain applications, especially where the work surface has a complicated topography, it may be desirable to generate a three-dimensional model of the work surface so that the pathways can be generated via computer and, if necessary, manually refined, instead of being manually generated. For such an event a variety of known techniques can be implemented. The three-dimensional model of the work surface can be manually modeled using computer design software or referenced from existing computer files. Alternatively, known scanning techniques exist which can generate a three-dimensional model, such as photogrammetry, laser, infrared, or ultrasonic scanning.

Once the three-dimensional model is prepared, it will be necessary to generate paths for the head assembly to follow along the work surface. The paths can be programmed into instructions for the computerized control system to execute in which it moves the conveyance appropriately to achieve the desired paths. In one embodiment, the head assembly paths can be generated in a similar fashion to the tool paths generated by standard computer aided machining (CAM) software. By way of example, in the simple scissor lift example disclosed above, the scissor lift can be treated as a two-dimensional router working on a two-dimensional surface and paths for the head assembly can be generated accordingly. In a more complicated example, such as where a man-lift is used to hydroblast a vessel hull, it may be more appropriate to treat the man lift as a five-axis router working on a three-dimensional surface. At least the following variables should be considered when generating pathways for the head assembly on CAM or other software: feed rate or speed of the head assembly necessary to achieve the desired surface finish, flow rate, water pressure, width of head assembly to calculate step over distance, geometric limitations of the conveyance, such as maximum boom angle or extension, obstructions in proximity to the work surface, and others. Once the pathways for the head assembly are generated, the pathways can be converted to machine code to be executed by the computerized control system, which is preconfigured to output the appropriate control signals to the drive system of the conveyance in order to move the head assembly according to the generated pathways.

In yet further embodiments, a variety of sensors can be deployed on the head assembly and/or conveyance for real time monitoring and feedback by an operator and/or the computerized control system. For instance, the head assembly may further comprise a sensor assembly configured to detect the distance between the head assembly and various obstacles present on the work surface, whether comprising the topography thereof, or other obstructions, barriers, or impediments which may prevent the head assembly from traversing the work surface. It may also be desirable to determine how far, and at what angle, various portions of the conveyance have extended. Alternatively, or in conjunction therewith, it may be understood such a sensor assembly may further be configured to detect a variety of other presences, whether physical properties, such as water pressure and water flow rate. For example, the computerized control system may be programmed to adjust the feed rate of the head assembly if water pressure or flow rate is not as anticipated in order to ensure that the work surface is prepared as anticipated. The system may also include a number of other sensors which can determine whether there is an unforeseen obstacle, such as a person, or unforeseen hazard, such as electrical or fire hazards that may be caused if the work surface is unintentionally damaged by the hydroblasting procedure. As may be understood, such sensor components may comprise, for instance, distance sensors, vison and imaging sensors, temperature sensors, pressure sensors, position sensors, motion sensors, gas and chemical sensors, photoelectric sensors, metal sensors, leak sensors, or any other sensor now known or hereafter developed. Likewise, such sensor components may comprise at least one transducer configured to monitor the vital signals of the system, thereby ensuring the head assembly is in proper condition for the operation thereof. All of the foregoing can be communicated to the computerized control system which is operative to take appropriate action, such as by turning the system off in case of emergency.

It should be appreciated that merely attaching an existing head assembly (meant to be used on floors) to a conveyance will not function effectively on vertical surfaces, upside down, or over complicated topography. Existing head assemblies have no means for holding a predetermined distance from the work surface without assistance from gravity. Additionally, they may not apply water or evacuate debris appropriately when oriented upside down or vertically. Finally, there are many components of existing head assemblies that can be separated and, for example, installed on non-articulating portions of the conveyance, to assist with stability and weight distribution of the system. Therefore, several mechanical and structural components, which facilitate the use of large head assemblies on conveyances and in vertical or upside-down orientations, are disclosed herein and should be taken as non-limiting and exemplary systems for implementing the principles present invention, namely, a large head assembly attachable to a conveyance which can be controlled via computerized means.

The system in accordance with at least one embodiment of the present invention may comprise a head assembly, which itself may comprise a chassis assembly, configured as the housing and/or mounting of the head assembly, disposed in connection with an applicator assembly, configured as the components through which the head assembly applies the hydroblasting fluid to a work surface. Specifically, such chassis assembly and applicator assembly may be operatively disposed such that such applicator assembly may be freely rotatable in at least one degree of freedom from such chassis assembly. In such manner, it may be understood such applicator assembly may float relative to such chassis assembly, thereby enabling such applicator assembly to remain positioned at an appropriate distance from the work surface, regardless of the orientation of the chassis assembly, and, by extension, the head assembly as a whole.

For instance, the chassis assembly in accordance with at least one embodiment of the present invention may comprise an upper chassis and a lower chassis. As used herein, the term “upper” refers to the portion of the head assembly furthest from the work surface, whereas the term “lower” refers to the portion of the head assembly disposed closest to the work surface. Such upper chassis and lower chassis may comprise two or more distinct components conjoined together or may alternatively comprise one single structure.

As previously stated, such upper chassis may comprise the portion of the chassis assembly disposed furthest from the work surface. Alternative embodiments of such upper chassis may comprise a variety of different shapes. For instance, such upper chassis may comprise a square or rectangular shape. Alternatively, such upper chassis may form alternative shapes, such as a triangular prism, an irregular prism, a half sphere, or any other shape now known or hereafter developed.

Further, the upper chassis of at least one embodiment of the present invention may have a rotatable coupling disposed thereon. Such a rotatable coupling may be configured for operative engagement with a conveyance, whether through an attachment arm or otherwise, thereby enabling such conveyance to move the head assembly. Further, such rotatable coupling may be configured to allow rotation in at least one degree of freedom, thereby enabling the head assembly of the present invention to be appropriately rotated for use with a work surface of varying orientations. For instance, such a rotatable coupling may comprise a universal joint or some other like component configured to provide such rotation.

The lower chassis of at least one embodiment of the present invention may comprise at least one mobility component or, alternatively, a plurality of mobility components. Such mobility component(s) may be disposed in operative engagement with the work surface and may be configured to allow the head assembly to move about the topography thereof. For instance, such mobility component(s) may comprise castor wheels in one embodiment of the present invention. For example, the lower chassis of at least one embodiment of the present invention may comprise a castor wheel arranged at each corner thereof, wherein each castor wheel may be configured for free rotation, static rotation, or any alternative thereof. Alternatively, such mobility component(s) may instead comprise any other type of component suitable for allowing the head assembly to traverse the topography of a work surface. For instance, such mobility component(s) may instead comprise alternative types of wheels, or alternative structures, such as a continuous track.

As may be understood, the dimensioning of the at least one mobility component may be configured to operatively dispose the head assembly, and the various components thereof, at an operative distance from the work surface. As such, it may be understood such at least one mobility component may be, in at least certain embodiments of the present invention, appropriately dimensioned so as to ensure the work surface remains at such operative distance from the head assembly, and more particularly the applicator, as discussed in greater detail hereafter, throughout the operation thereof.

In such an embodiment, the upper chassis and the lower chassis may be conjoined with a biasing assembly disposed there between. Such a biasing assembly may comprise, for instance, at least one, and in some instances a plurality of biasing members, such as springs. Such biasing members may be configured to absorb force, such as those provided by the irregular topography of a work surface. Accordingly, such biasing members may be configured to shift between a first position, namely the position of the biasing members when at rest, and a second position, namely the position when force is applied to the biasing members. In so doing, the biasing members of at least one embodiment of the present invention may be configured to compress into a second position when the head assembly traverses irregular topography, thereby enabling such head assembly to easily traverse any given work surface.

Disposed in connection with each biasing member may be, for instance, an inner pipe and an outer pipe, wherein such inner pipe may be configured for the attachment of at least one side of the biasing members, whereas the outer pipe may be configured to cover or otherwise shield the biasing members, thereby protecting such biasing members from external components. Accordingly, such inner pipe and outer pipe constitute attachment and safety points. In alternative embodiments, either, or both, of such inner pipe and outer pipe may be unnecessary. For instance, in one alternative embodiment, such biasing members may simply be disposed about a chassis rod, such as a thread rod, wherein such chassis rod may be disposed to be attached to both the upper chassis and the lower chassis, thereby providing structural support there between. As may be understood, such chassis rod may, in at least one embodiment of the present invention, be disposed in sliding engagement with at least one of the upper chassis and the lower chassis, such that the upper chassis and/or the lower chassis may move along with the biasing members.

Returning to the lower chassis, at least one embodiment of the present invention may have an applicator assembly disposed in connection therewith. Such an applicator assembly may be configured to apply high pressure fluid, such as water, to the work surface, thereby effectuating the cleaning and/or destructive purposes of a hydroblaster system. Accordingly, such an applicator assembly may comprise an applicator, which may itself comprise a spray bar or any other like apparatus configured to apply high pressure fluid to a work surface, whether now known or hereafter developed. In at least one embodiment of the present invention, such an applicator may comprise at least one, and in most instances a plurality of applicator outlets, configured to apply a high-pressure fluid to the work surface. Such applicator outlet(s) may comprise, for instance, nozzles or any other like component. As may be understood, such applicator may be disposed below the lower chassis, such that such applicator is disposed closer to the work surface than the lower chassis. In at least one embodiment of the present invention, such applicator may be configured to rotate about an axis of rotation, such as the center of mass of such applicator, such that any applicator outlets disposed thereon are rotated during operation, thereby enabling such applicator outlets to be applied to the entirety of a work surface.

Such an applicator assembly may further comprise a pump assembly configured to receive the fluid to be applied to the work surface from a source, and direct same to the applicator. Such pump assembly may, in at least one embodiment, be disposed above the lower chassis, such that the pump assembly is disposed further from the work surface than the lower chassis itself. Accordingly, it may be understood the lower chassis, in such an embodiment, may effectively support the pump assembly. Further, it may be understood such pump assembly may be operatively disposed in fluid communication with the applicator, such that any fluid flowing into the pump assembly may be transmitted to the applicator for its application to the work surface.

Such a pump assembly may comprise, in certain embodiments of the present invention, a plurality of different components configured for application in a high-pressure fluid environment. For instance, such a pump assembly may comprise a pump component, such as a positive-displacement pump, configured to move the fluid through the pump assembly. Disposed in connection with such pump component may be a valve component, such as a high-pressure seat valve, and/or a piston component, each of which may be configured to direct the flow of the fluid throughout the pump assembly. Further, such a pump assembly may also comprise at least one pump inlet and at least one pump outlet, through which the fluid may be both received into, and transmitted out of, the pump assembly.

Further, the pump assembly of at least one embodiment of the present invention may also comprise at least one rotating manifold. Such a rotating manifold may be disposed in fluid communication between the aforementioned components of the pump assembly, and the applicator itself, such that any fluid flowing into and out of the pump assembly may also flow through a rotating manifold prior to flowing into the applicator. Such a rotating manifold may comprise, for instance, a swivel joint or a flexible joint, or any other component akin thereto, and may be configured to allow angular misalignment between the pump assembly and the applicator whilst maintaining fluid communication there between.

Accordingly, in such an embodiment, it may be understood the applicator, when disposed in connection with such a rotating manifold, may be allowed to rotate freely from the pump assembly, the lower chassis connected thereto, and by extension the entirety of the head assembly, whilst still providing a high-pressure fluid to the work surface. As such, the applicator of such an embodiment may be understood as having a floating functionality, wherein the applicator may be biased to align itself with the topography of the work surface, thereby ensuring the applicator remains appropriately oriented at a sufficient distance from the work surface for the effective hydroblasting thereof. Such orientation may, in at least some embodiments, comprise the applicator disposed substantially parallel and/or squared to the work surface, such that fluid expelled from the applicator may orthogonally engage the work surface.

The head assembly of at least one embodiment of the present invention may further comprise an oscillation assembly. Such an oscillation assembly be disposed in connection with the applicator assembly, and more specifically the applicator itself, to provide an oscillatory motion thereto. More specifically, such an oscillation assembly may be configured to allow the applicator to oscillate between an initial applicator position and a secondary applicator position, thereby enabling the applicator to continuously oscillate during operation, and thus apply the high-pressure fluid to the entirety of the work surface. In at least one embodiment of the present invention, the oscillation assembly may be configured to allow the applicator to oscillate in a direction transverse to the direction the head assembly itself is moving. However, alternative embodiments of the present invention may be configured to allow the applicator to oscillate in alternative directions, or instead, to rotate about an axis of rotation.

The oscillation assembly of at least one embodiment of the present invention may comprise an upper track and a lower track. Such upper track and lower track may be integrally formed into either, or both, the upper chassis and/or the lower chassis. Alternatively, such upper track and lower track may instead be components distinct from the upper chassis and lower chassis. Each such upper track and lower track may comprise, for instance, pins, rails, or any other like structure upon which a component may be disposed and configured for movement there along.

In such an embodiment, the lower track may be configured for operative engagement with the applicator. More specifically, the applicator may be disposed on and/or about the lower track, such that the lower track supports the applicator. Even further, such applicator may be disposed in connection with such lower track such that the applicator may move longitudinally along such lower track, thereby enabling such applicator to shift between the aforementioned initial applicator position and the secondary applicator position. In accordance therewith, it may be understood the lower track of at least one embodiment of the present invention may comprise beams upon which the applicator may be slidably disposed, rails upon which wheels or other components may be disposed for attachment to the applicator, or any other like structure configured to enable the foregoing sliding functionality.

The upper track of such an embodiment may be configured for operative engagement with a drive mechanism. Such drive mechanism may be disposed on and/or about such upper track, and may be configured to move longitudinally along such upper track. Such a drive mechanism may comprise, for instance, a drive motor or any other like apparatus configured to provide movement along such upper track. Disposed in connection with such drive mechanism may be an attachment apparatus, such as an arm or stem, which may be attached to the applicator. Accordingly, it may be understood any movement provided by the drive mechanism may be imparted onto the applicator via the attachment apparatus. In this manner, it may be understood the longitudinal movement of the drive motor may impart longitudinal movement on the applicator, thereby providing the oscillatory movement of the oscillation assembly. As may be understood, such drive mechanism may be configured to travel about the entire longitudinal length of such upper track, or only a portion thereof.

Likewise, alternative embodiments of such a drive mechanism are envisioned herein. For instance, such a drive mechanism may instead comprise, for instance, a gear arrangement through which longitudinal movement may be imparted onto the applicator via attachment of such gear arrangement thereto. In such an embodiment, it may be understood such upper track may not be necessarily dependent upon the structure and functionality of the drive mechanism itself. For instance, such a gear mechanism may have a gear component comprising at least one bevel gear and/or miter gear configured to change the direction of power transmission of such gear mechanism. Alternatively, it may be understood such upper track may itself have teeth disposed thereon, for engagement with the teeth of at least one gear component of such gear mechanism.

Further, at least one embodiment of the oscillation assembly of the present invention may further comprise a counterbalance. Such counterbalance may be disposed in connection with the drive mechanism and/or the applicator such that the counterbalance is disposed in a longitudinal position opposite to the applicator and/or drive mechanism. More specifically, when such drive mechanism and/or applicator is disposed in a position nearer one of the ends of the head assembly, it may be understood such head assembly will be unbalanced. Because such head assembly can be quite heavy, and may be traversing uneven terrain, it may be understood such unbalanced load may be detrimental to the operation of the head assembly, at least imparting unnecessary strain on the components thereof. As such, a counterbalance may be disposed in connection with the drive mechanism and/or applicator to ensure the weight distribution of the head assembly remains in balance throughout the oscillatory motion of the applicator. Accordingly, it may be understood such counterbalance may be configured to longitudinally traverse the lower beam, for instance, and may comprise an operative weight configured to retain the weight of the head assembly in a state of at least partial equilibrium. As may be understood, alternative embodiments of such a counterbalance, and its interaction with the drive mechanism and/or head assembly are envisioned herein.

As previously discussed, the head assembly of the present invention may, in at least one embodiment of the present invention, be disposed in connection with a conveyance. As previously discussed, such attachment to a conveyance may occur through the rotatable coupling disposed on the upper chassis of the head assembly, thereby operatively engaging the head assembly to the conveyance. As may be understood, such rotatable coupling may be configured for operative engagement with any number of conveyances, the selection of which may be dependent upon the work surface to be treated by the head assembly. As such, it may be understood the rotatable coupling of at least one embodiment of the present invention may be removably engaged with any one conveyance, such that the head assembly may be removed from any one conveyance, and reengaged with a different conveyance, thereby providing the user of the head assembly the ability to dispose any one head assembly on numerous conveyances for the purpose of treating a variety of work surfaces.

For instance, the conveyance of alternative embodiments of the present invention may comprise a man lift, a track hoe, a scissor lift, a boom, a scaffolding or some other frame and/or track system, a wheeled cart, or any other conveyance whether now known or hereafter developed. At least some of the types of conveyances which may utilized by at least one embodiment of the present invention, and the manner in which the head assembly of at least one embodiment of the present invention may be utilized in connection therewith, will be discussed in greater detail hereafter. However, as may be understood, such conveyances, their interaction with the head assembly, and their applications with respect to a given work surface are merely exemplary, as myriad conveyances and applications are envisioned herein.

A conveyance in accordance with at least one embodiment of the present invention may comprise a truck. As may be understood, such a conveyance may have a connecting arm, such as a beam or rod, extending therefrom, wherein such connecting arm may be operatively engaged with the rotatable coupling of the head assembly. As such, it may be understood the truck may push, pull, or otherwise move the head assembly about a floor, which may itself be flat or comprised of irregular topography. Such a conveyance may comprise additional components disposed in connection therewith, such as a vacuum component configured to collect any particles and/or debris dislodged by the head assembly. Accordingly, such vacuum component may be disposed at the opposite end of the head assembly, such that the vacuum component reaches the work surface after it has already been treated by the head assembly. Likewise, it may be understood such a conveyance may be configured for the disposition of a plurality of head assemblies thereon, thereby increasing the amount of surface area that may be treated at any given time by such conveyance.

In another embodiment of the present invention, a conveyance used in connection with the head assembly may be configured to allow such head assembly to treat a work surface comprising a wall, although the use thereof with other types of work surfaces is envisioned herein. Such a conveyance may comprise, for instance, a man lift disposed in connection with the head assembly. Such man lift may be attached directly to the head assembly, through the rotatable coupling, or may instead have an intervening component disposed there between, such as a man basket configured to house an operator of the conveyance and/or the head assembly. As such, it may be understood such a conveyance may have at least one attachment arm disposed thereon, wherein such attachment arm may be configured to move the head assembly about the work surface.

Alternatively, an additional embodiment of the present invention may instead provide a conveyance comprising a scaffold assembly, which may be configured to allow the head assembly to likewise be applied to a wall, such as an interior wall of a large tank. Such a scaffold assembly may comprise, for instance, a wheel-and-track system configured to allow the scaffold assembly to move about the floor. Further, such a scaffold assembly may comprise a cable assembly configured to adjust the height at which the head assembly is applied. Such a cable assembly may comprise, for instance, a cable arm, disposed in connection with the head assembly. Such cable arm may further be disposed in connection with a guide bar and a backing bar, which may each be configured to provide structural support for the attachment arm while also providing a track upon which the attachment arm may move. Further, disposed in connection with such cable arm may be a cable system, which may comprise at least one cable, disposed in connection with at least one pulley, wherein the tension of the cable(s) may be adjusted by a winch disposed in connection therewith. In such manner, it may be understood the winch may be used to pull in or let out the cable, which, due to its engagement with the cable arm, may enable the cable arm to vertically shift positions on the scaffold assembly. In so doing, it may be understood the head assembly may thus be vertically moved about the scaffold assembly, thereby enabling the entire area of the work surface to be treated.

Yet another embodiment of the present invention may provide for the head assembly to be used in connection with a ceiling. A conveyance for such an embodiment may comprise, for instance, a wheeled cart having a moveable or extendable beam disposed thereon. Such a beam may be attached to the head assembly through the rotatable coupling. Such a conveyance may further comprise, for instance, a control arm, or some other like component configured to move the conveyance.

Likewise, further embodiments of the present invention may comprise a mounting assembly disposed between such head assembly and such conveyance. Thus, as may be understood, such mounting assembly may be disposed to attach the head assembly to any conveyance intended to be used in connection therewith.

For instance, one embodiment of such a mounting assembly may comprise an attachment component configured to be attached to a given conveyance. Disposed in connection with such an attachment component may be a brace component, configured to provide structural rigidity to such mounting assembly. In at least one embodiment of the present invention, such a brace component may comprise two disparate beams, wherein each such beam may be attached to an attachment arm, upon which the head assembly may be mounted. As may be understood, in at least one embodiment of the present invention, such attachment arm may have a plate component disposed thereon, for attachment to the head assembly. Further, such plate component may be disposed in connection with a swivel component, which may allow the head assembly to rotate relative to the attachment arm. As may be understood, such swivel component may be configured such that the rotatable coupling of the head assembly is unnecessary.

Alternatively, different embodiments of the mounting assembly may instead comprise alternative structures configured to likewise mount the head assembly onto a given conveyance. For instance, one such embodiment of the mounting assembly may instead comprise a receiver component configured to be attached onto a conveyance. Such a receiver component may be configured in connection with a pin, such that the receiver component may flex, or otherwise bend, in at least one direction, thereby enabling the remaining portions of the mounting assembly to move relative to the conveyance. Once again, an embodiment of such mounting assembly may comprise a brace component configured to provide structural rigidity to the mounting assembly, wherein such brace component may be disposed in connection with an attachment arm, to which the head assembly may be attached. In such an embodiment, such brace component may only comprise one beam. Even further, in such an embodiment, the interconnection between such brace component and such attachment arm may comprise a mounting hinge disposed in connection with a mounting biasing element, the conjunction of which may enable the attachment arm to rotate relative to the brace component. Disposed at one end of such attachment arm may be a plate component configured for attachment with the head assembly. In such an embodiment, such a plate component may have at least one fastener component disposed thereon, wherein such fastener component(s) may facilitate the connection between the plate component and the head assembly.

As may be understood, the foregoing conveyances for application of the head assembly in connection with a wall and/or a ceiling present several additional problems. For instance, one such problem pertains to disposing the head assembly in an orientation whereby the same may be negatively impacted by gravity. In other words, in each such application of the head assembly, it may be understood the conveyance of the various embodiments of the present invention may be required to apply a certain amount of force to the head assembly, to ensure the same always remains in sufficient contact with the work surface.

Accordingly, the conveyance in accordance with various embodiments of the present invention may comprise a pneumatic assembly disposed in connection therewith. As may be understood, dependent upon the particular conveyance used in connection with the head assembly, such a pneumatic assembly may be disposed on different portions thereof. For instance, in the aforementioned conveyances to allow for the head assembly to be used in connection with a wall or a ceiling, namely a man lift, a scaffold assembly, and a wheeled cart, it may be understood the pneumatic assembly may be disposed on the attachment arm and/or the moveable beam of such conveyances. Alternatively, it may be understood the pneumatic assembly may itself comprise such attachment arm and/or moveable beam, thereby vitiating the need for a conveyance to have such components disposed thereon.

As previously stated, such pneumatic assembly may be configured to ensure the head assembly retains proper connection with the work surface, such as a wall, ceiling, or otherwise throughout its operation. As such, it may be understood the pneumatic assembly in accordance with at least one embodiment of the present invention may be configured to apply force to the head assembly, thereby applying normal force from the head assembly and onto the work surface. More specifically, the pneumatic assembly of at least one embodiment of the present invention may be configured to apply constant pressure to the head assembly.

In at least one embodiment of the present invention, such a pneumatic assembly may comprise a housing having an outer seal and an inner seal, wherein such inner seal may be disposed to create an air chamber at one end of the pneumatic assembly, whilst a piston chamber may be formed between the outer seal and the inner seal. Disposed in connection with the inner seal may further be a piston, which may be attached to a moveable plate disposed outside of the housing, beyond the outer seal. In certain embodiments, such moveable plate may be attached to an attachment arm or a moveable beam of a given conveyance, or, conversely, to the head assembly itself. Further, disposed in connection with such piston and the outer seal may be a pneumatic biasing element, such as a spring. As such, it may be understood the piston, due to the biasing force applied from the pneumatic biasing element, may be predisposed to an initial orientation.

Further, such a pneumatic assembly may comprise a variety of components configured to control air flow into and out of the same. Specifically, disposed in connection with the air chamber may be an air inlet and an air outlet. Such air inlet may comprise, for instance, an air regulator. Such air outlet may comprise, for instance, a discharge valve. As such, it may be understood the air inlet and the air outlet may be used to control the amount of air disposed within the air chamber at any given point in time. In so doing, the piston may be driven by the pressurized air chamber, when such pressure is greater than the force applied by the pneumatic biasing element. As may be understood, such driving of the piston, and by extension the inner seal, will necessarily adjust the volume of the piston chamber. Accordingly, to ensure the pressure of such piston chamber does not fluctuate in accordance with the fluctuating volume of same, a piston vent may be disposed in connection with the piston chamber, thereby enabling the air disposed within the piston chamber to freely flow into and out of the same.

As such, it may be understood the pneumatic assembly of at least one embodiment of the present invention may be configured to expand and/or contract dependent upon the amount of air pressure disposed within the air chamber. For instance, in an embodiment wherein the movable plate of the pneumatic assembly is disposed in connection with an attachment arm, which itself is disposed in connection with the head assembly, it may be understood the linear expansion of the moveable plate may linearly move the attachment arm, and by extension the head assembly. Once the head assembly is disposed in sufficient engagement with the work surface, such pneumatic assembly may then reach a level of equilibrium, wherein no additional airflow into and/or out of the air chamber is required, thus enabling the pneumatic assembly to provide an at least substantially constant amount of force to the head assembly. Likewise, it may be understood the pneumatic assembly may apply variable amounts of force to the head assembly, thereby controlling the level of engagement between such head assembly and the work surface.

As previously stated, applying the head assembly to a work surface such as a wall or ceiling presents several problems, such as the aforementioned problem pertaining to the amount of force required to ensure the head assembly remains in proper engagement with the work surface. One other such problem pertains to the possibility of debris falling of the ceiling. In instances wherein a user is controlling the conveyance and/or head assembly, instances of falling debris and/or fluid should be mitigated or vitiated.

Accordingly, one additional embodiment of the present invention may comprise a head assembly featuring yet additional components. Specifically, such an embodiment of the head assembly may further comprise an enclosure assembly configured to trap any such falling debris and safely remove the same from the head assembly. Such enclosure assembly may comprise, for instance, a funnel structure disposed over and around the head assembly. As such, the enclosure assembly may, in at least certain embodiments, be configured to cover a broader area of the work surface than the applicator, thereby enabling such enclosure assembly to collect any and all debris and/or fluid during operation of the head assembly.

In connection with such enclosure assembly may be a vacuum assembly. Such vacuum assembly may comprise, without limitation, vacuum lines disposed to transport any such debris and/or fluid out of the enclosure assembly. Such vacuum lines may be disposed in connection with at least one receptacle, which may be disposed on the conveyance in at least certain embodiments of the present invention. As such, it may be understood any debris and/or fluid falling off a work surface, such as a ceiling, may be collected by the enclosure assembly, removed therefrom, and subsequently transported to a receptacle for disposal. Alternatively, it may be understood such vacuum assembly may likewise be disposed without the enclosure assembly in certain embodiments, such as those wherein the head assembly is intended to treat a work surface comprising a floor.

Likewise, in at least one embodiment of the present invention, it may be understood such a vacuum assembly may instead be disposed on a head assembly configured for use on a work surface comprising a floor. In such an embodiment, it may be understood such vacuum assembly may thus be configured to collect debris disposed underneath the head assembly, such that any particles or other debris resulting from the hydroblasting operations are therefore removed from the work surface by the vacuum assembly.

Further embodiments of the present invention may incorporate yet additional features. For instance, certain embodiments of the present invention may include a head assembly comprising certain sensor components and/or electrical computing systems configured to enable the head assembly, and perhaps the conveyance connected therewith, to monitor signals and data. For instance, in one embodiment of the present invention, such sensor components may be configured to detect the presence of nearby objects. Accordingly, at least one embodiment of the present invention is configured for the autonomous and/or remote control of the head assembly and/or conveyance(s), such that a user need not actually control either such component during hydroblasting operations.

### BRIEF DESCRIPTION OF THE DRAWINGS

For a fuller understanding of the nature of the present invention, reference should be had to the foregoing detailed description taken in connection with the accompanying drawings in which views of various embodiments of the present invention are presented.

FIG. 1A depicts a head assembly in accordance with at least one embodiment of the present invention.

FIG. 1B depicts a head assembly in accordance with at least one embodiment of the present invention.

FIG. 2A depicts a bottom view of an applicator utilized by the head assembly of at least one embodiment of the present invention.

FIG. 2B depicts a bottom view of an applicator utilized by the head assembly of at least one embodiment of the present invention.

FIG. 3 depicts a schematic view of a pump assembly, in accordance with at least one embodiment of the present invention.

FIG. 4 depicts a front view of a head assembly in accordance with at least one embodiment of the present invention, wherein the head assembly depicted comprises an oscillation assembly.

FIGS. 5A-5C depict front schematic views of an oscillation assembly in accordance with at least one embodiment of the present invention, wherein the applicator of the oscillation assembly is serially disposed in an initial position, a secondary position, and a tertiary position, respectively.

FIG. 6 depicts a schematic view of a system of interconnected head assemblies and operator consoles.

FIG. 7A depicts a side view of a mounting assembly, in accordance with at least one embodiment of the present invention.

FIG. 7B depicts a side view of a mounting assembly, in accordance with at least one embodiment of the present invention.

FIG. 8 depicts a side view of a head assembly disposed in connection with a conveyance, in accordance with at least one embodiment of the present invention, wherein the conveyance depicted therein comprises a truck.

FIG. 9 depicts a top view of a plurality of head assemblies disposed in connection with a conveyance, in accordance with at least one embodiment of the present invention.

FIG. 10 depicts a side view of a conveyance disposed in connection with a head assembly, in accordance with at least one embodiment of the present invention, wherein the conveyance depicted therein is a man lift.

FIG. 11 depicts a side view of a head assembly disposed in connection with a conveyance and a pneumatic assembly, in accordance with at least one embodiment of the present invention, wherein the conveyance depicted therein comprises a scaffolding system

FIG. 12 depicts a front view of a pneumatic assembly in accordance with at least one embodiment of the present invention.

FIG. 13 depicts a side view of a head assembly disposed in connection with a pneumatic assembly, for operation in connection with a wall, in accordance with at least one embodiment of the present invention.

FIG. 14 depicts a side view of a head assembly disposed in connection with a conveyance and a pneumatic assembly in accordance with at least one embodiment of the present invention, wherein the conveyance depicted comprises wheeled cart.

FIG. 15 depicts an isometric view of a head assembly disposed in connection with a pneumatic assembly, for operation in connection with a ceiling, in accordance with at least one embodiment of the present invention.

FIG. 16 depicts a top schematic view of a plurality of head assemblies disposed on a work surface having a plurality of boundary components disposed thereon, in accordance with at least one embodiment of the present invention.

Like reference numerals refer to like parts throughout the several views of the drawings.

### DETAILED DESCRIPTION OF THE INVENTION

The present invention is directed towards a hydroblasting system comprising a head assembly 100, wherein the head assembly 100 may be disposed in connection with a conveyance 200 such that the head assembly 100 may be applied across a work surface 101. More specifically, the present invention comprises a head assembly 100 which itself may comprise a plurality of components configured to enable such head assembly 100 to be applied to a work surface having an irregular topography. Even further, the present invention may additionally comprise further components disposed in connection with such head assembly 100, which may enable such head assembly 100 to be employed on work surfaces such as walls and ceilings, or further enabling such head assembly 100 to be used as part of an autonomous hydroblasting system.

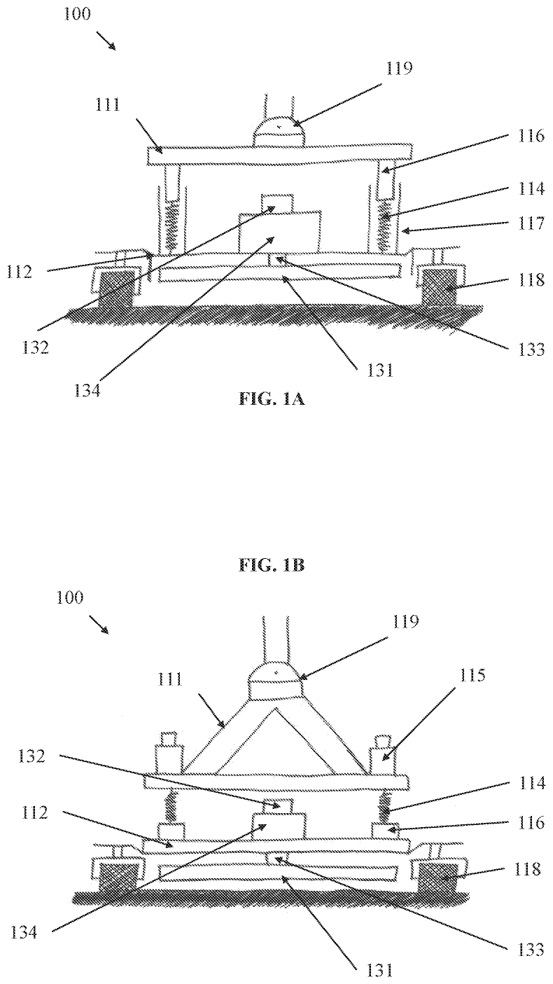

For instance, two alternative embodiments of the head assembly 100 are depicted in FIGS. 1A and 1B. As may be seen, each such head assembly 100 may comprise a chassis assembly 110, which may comprise an upper chassis 111 disposed in connection with a lower chassis 112. As previously stated, the term “upper” as used herein refers to the portion of the head assembly disposed furthest from the work area, whereas the term “lower” refers to the portion of the head assembly disposed closest to the work surface. As depicted in FIGS. 1A and 1B, the upper chassis 111 and the lower chassis 112 may comprise two distinct components, connected through other components of the head assembly 100. However, alternative embodiments envisioned herein may instead comprise a head assembly 100 having an upper chassis 111 and a lower chassis 112 formed of one single structure.

As may be seen with continued reference to FIGS. 1A and 1B, the chassis assembly 110, and particularly the upper chassis 111 of alternative embodiments of the present invention may comprise a variety of different shapes, whether comprising a square or rectangular shape, a triangular prism, an irregular prism, a half sphere, or any other shape now known or hereafter developed. Likewise, such lower chassis 112 may comprise a variety of different shapes as well.

Additionally, it may be noted the upper chassis 111 of at least one embodiment of the present invention may have a rotatable coupling 119 disposed thereon. Such a rotatable coupling 119 may be configured for operative engagement with a conveyance 200, whether through an attachment arm or otherwise, thereby enabling such conveyance to move the head assembly 100. Further, such rotatable coupling 119 may be configured to allow rotation of such head assembly 100 in at least one degree of freedom, such that the head assembly 100 may be appropriately rotated for use on a work surface having varying orientations, independent of the orientation of the conveyance 200 and/or the attachment arm thereof. Such a rotatable coupling 119 may comprise, for instance, a universal joint, a ball point, or any other like component configured for the aforementioned functionality associated with such rotatable coupling 119.

With continued reference to FIGS. 1A and 1B, it may be seen the lower chassis 112 may comprise at least one, and in some cases a plurality of, mobility component(s) 118 disposed thereon. Such mobility component(s) 118 may be disposed in operative engagement with the work surface 101 when the head assembly 100 is in operation and may further be configured to allow the head assembly 100 to move about the topography of the work surface 101. Alternative embodiments of the present invention may comprise alternative types of mobility component(s) 118, such as castor wheels, whether arranged for free or static rotation, or some variation thereof, or alternative types of wheels, or even a continuous track system.

Further, such mobility component(s) 118 may be configured to dispose the head assembly 100, and the various components thereof, at an operative distance from the work surface 101. As such, it may be understood such mobility component(s) 118 may, in at least certain embodiments, be appropriately dimensioned to ensure the work surface 101 remains at such operative distance from the head assembly 100, and the various components thereof.

As may be seen with continued reference to FIGS. 1A and 1B, at least one embodiment of the head assembly of the present invention may comprise such upper chassis 111 and lower chassis 112 may be conjoined via a biasing assembly 113 disposed there between. More particularly, such upper chassis 111 and lower chassis 112 may be conjoined via a plurality of biasing members 114, such as springs, wherein such biasing members 114 are configured to absorb force, such as that provided by the irregular topography of a given work surface 101.

As may be understood, such biasing assembly 113, and by extension the upper chassis 111 and the lower chassis 112 as well, may be configured to shift between a first position, namely when the biasing members 114 are at their initial position when no force is applied thereto, and a second position, namely when the biasing members 114 are compressed upon the application of force thereto. As may further be understood, the biasing assembly 113 of at least one embodiment of the present invention may be configured in connection with the mobility component(s) 118, thereby forming an at least partially independent suspension. In so doing, it may be understood at least one, or, in some embodiments, all of the mobility components 118, and, by extension, each biasing member 114 of the biasing assembly 113, may be independently moveable with respect to the remaining mobility components 118 and biasing members 114. Accordingly, it may be understood the shifting between the first position and the second position of the biasing members 114 may enable such mobility component(s) 118 to react to the irregular topography of a work surface 101, and thereby enable the head assembly 100 to easily traverse the same.

Alternative embodiments of the present invention may utilize alternative structural arrangements to dispose the biasing assembly 113 in connection with the chassis assembly 110. For instance, as depicted in FIG. 1A, the head assembly 100 of at least one embodiment of the present invention may utilize an inner pipe 116 and an outer pipe 117, wherein the biasing member 113 is attached to the inner pipe 116 and covered by the outer pipe 117. Alternatively, as depicted in FIG. 1B, such biasing member 113 may instead be disposed in connection with the chassis assembly 110 via a lower attachment component 117′ and a fastener component 115, such as an all-thread rod disposed in connection with a lock nut.

As depicted in FIGS. 1A and 1B, the head assembly 100 of various embodiments of the present invention may further comprise an applicator assembly 130 disposed in connection with the chassis assembly 110. More specifically, such applicator assembly 130 may be disposed in connection with the lower chassis 112 such that the applicator 131 is disposed at the lower portion of the head assembly 100, and thus is disposed near the work surface 101. Such an applicator assembly 130 may be configured to apply a high-pressure fluid, such as water, to the work surface, thereby effectuating the cleaning and/or destructive purposes of the hydroblaster system.

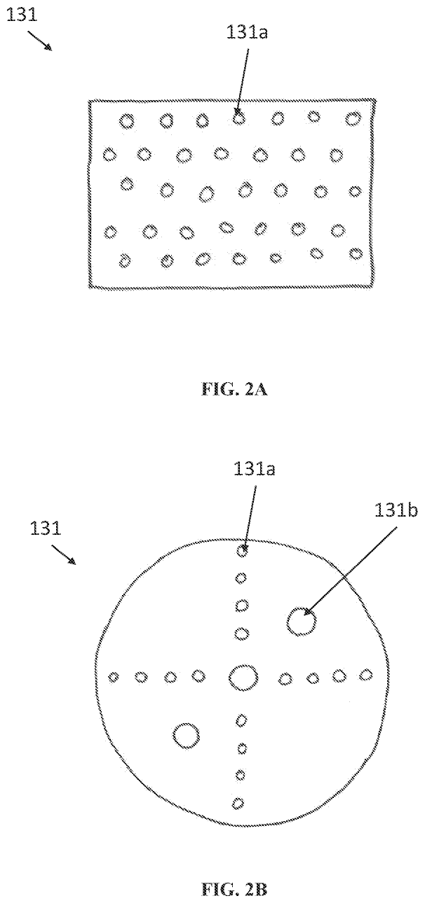

As such, the applicator assembly 130 may comprise an applicator 131 having at least one, in some instances a plurality, of applicator outlet(s) 131a disposed thereon, wherein such applicator outlet(s) 131a may be configured to apply high pressure fluid to a work surface, and may comprise, for instance, nozzles or spray tips, such as those made from crystal or sapphire. As may be seen with reference to FIGS. 2A and 2B, such applicator 131 may comprise various shapes in various embodiments, whether rectangular, circular, or otherwise, as depicted in FIG. 2A and FIG. 2B. Such an applicator 131 may further comprise other components, such as vacuum lines 131b disposed therein, which may facilitate the use of such applicator 131 on work surfaces 101 such as a ceiling and/or wall. In at least one embodiment, such applicator 131 may be disposed beneath the lower chassis 112, such that the applicator 131 is operatively disposed at a location closer to the work surface 101 than the lower chassis 112.

Returning to FIGS. 1A and 1B, the applicator assembly 130 of at least one embodiment of the present invention may further comprise a pump assembly 134 configured to receive the fluid to be applied to the work surface 101, and further direct such fluid to the applicator 131. As such, it may be understood such pump assembly 134 may be operatively disposed in fluid communication with such applicator 131. In certain embodiments, such pump assembly 134 may be disposed above the lower chassis 112, such that the lower chassis 112 at least partially supports such pump assembly 134. Such a pump assembly 134 may comprise, in at least one embodiment, a plurality of different components configured for application in a high-pressure fluid environment. For instance, such pump assembly may comprise a pump component 135, such as a positive-displacement pump or an air diaphragm, configured to move the fluid through the pump assembly.

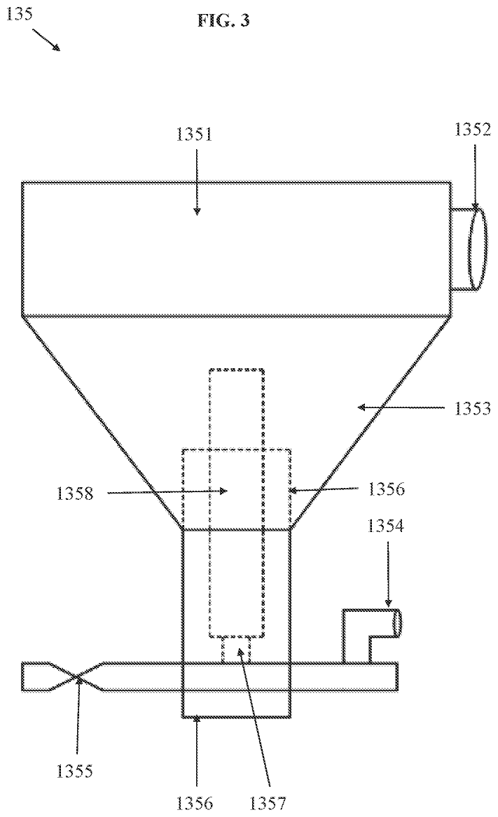

For instance, as depicted in FIG. 3, such a pump component 135 may comprise a fluid chamber 1351 disposed in fluid communication with a fluid channel 1352, into which a given fluid, such as the high-pressure water utilized by the head assembly 100, may be configured to flow both into and out of. Accordingly, such fluid channel 1352 may represent an ingress and egress point into the fluid chamber 1351, and thus may be attached to lines or other components configured for the transportation of a fluid both into and out of the fluid chamber 1351. Alternatively, it may be understood such fluid channel 1352 may instead comprise two separate components, namely, one for fluid ingress and one for fluid egress.

Disposed in connection with such fluid chamber 1351 may be an air diaphragm chamber 1353. In one embodiment, such air diaphragm chamber 1353 may be configured to be flexible, wherein such air diaphragm chamber 1353 may both expand and contract, thereby applying pressure, or a lack thereof, onto the fluid chamber 1351. In the embodiment depicted in FIG. 3, such flexibility of the air diaphragm chamber 1353 may be conferred via the diaphragm piston component 1358, which may be configured to move between an extended position and a contracted position, thereby expanding and contracting the air diaphragm chamber. Such diaphragm piston component 1358 may be securely affixed onto the pump component 135 via a piston seat 1357, which may comprise any appropriate fastener, fixture, or other like component. Further, such diaphragm piston component 1358 may be disposed within a diaphragm piston chamber 1356. As may be understood, such diaphragm piston chamber 1356 may be fully enclosed, but attached to a diaphragm inlet 1354 and diaphragm outlet 1355, such that air or some other gaseous medium may be withdrawn into the diaphragm piston chamber 1356 and expelled therefrom. In so doing, the resultant increase and decrease of pressure within the constant volume of the fully enclosed piston diaphragm piston chamber 1356 may therefore drive the diaphragm piston component 1358 into the aforementioned extended and contracted positions, thereby driving the air diaphragm chamber 1353 to both expand and contract.

Accordingly, it may be understood the expansion and contraction of the air diaphragm chamber 1353 may result in the ingress and egress of fluid into and out of the fluid chamber 1351. For instance, upon contraction of the air diaphragm chamber 1353, a vacuum may result in the fluid chamber 1351, thereby withdrawing a certain amount of fluid into the fluid chamber 1351. Then, upon the expansion of the air diaphragm chamber 1353, the fluid disposed within the fluid chamber 1351 will therefore be expelled therefrom.

Further, as depicted in FIGS. 1A and 1B, the pump assembly 134 of various embodiments of the present invention may additionally comprise at least one rotating manifold 133. Such a rotating manifold 133 may be disposed in fluid communication between the pump component 135 and the applicator itself 131, such that any fluid flowing into and out of the pump assembly 134 may flow through the rotating manifold 133 prior to flowing into the applicator 131. Such a rotating manifold 133 may comprise, for instance, a swivel joint or a flexible joint, or any other like component configured to allow for the angular misalignment between the pump assembly 134 and the applicator 131 whilst maintaining both fluid communication and fluid flow there between.

Accordingly, it may be understood such an embodiment wherein the applicator 131 is disposed in connection with such a rotating manifold 133 may be configured to allow such applicator 131 to rotate freely in relation to the pump assembly 134, and by extension the remaining portions of the head assembly 100, whilst still providing high pressure fluid to the work surface 101. As such, the applicator 131 in such an embodiment may be understood to have a floating functionality, wherein the applicator 131 may self-align itself with the topography of the work surface 101. Thus, in so doing, such an applicator 131 may remain appropriately oriented at an optimal distance from the work surface 101. More specifically, such applicator 131 may remain substantially parallel to the work surface 101 throughout the operation of the head assembly 100. Accordingly, the fluid expelled from the applicator 131 may orthogonally engage the work surface 101, thus ensuring the fluid expelled from the applicator 131 is applied at the best angle.

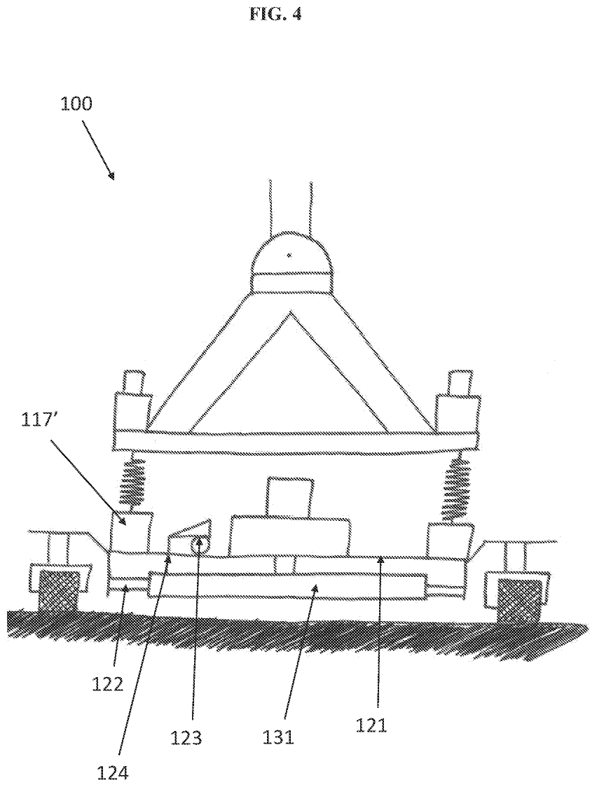

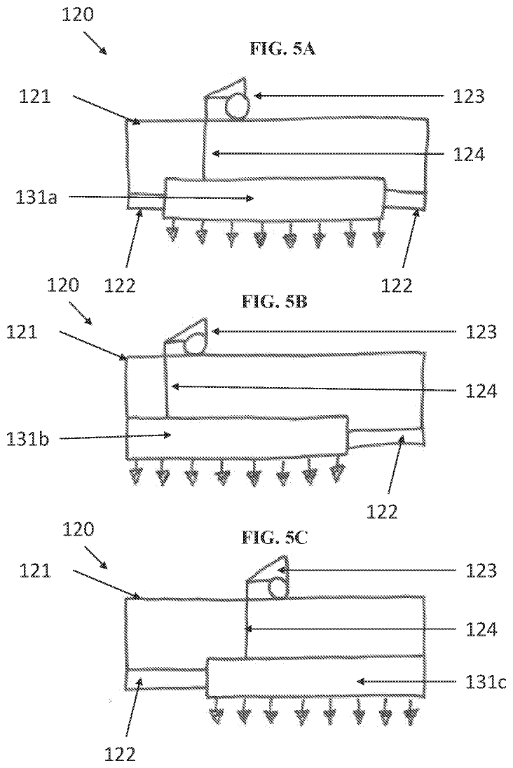

Yet additional embodiments of the head assembly 100 of the present invention may comprise additional components. For instance, at least one such embodiment of the head assembly 100, such as the one depicted in FIGS. 4 and 5A-5C, may further comprise an oscillation assembly 120, which may be configured to move the applicator 131 in an oscillatory, back-and-forth, vibratory, and/or positionally-dynamic motion, thereby enabling the fluid expelled from such applicator 131 to be applied to the entirety of the work surface 101, independent from the movement of the head assembly 100 itself. More specifically, the oscillation assembly 120 of at least one embodiment may be configured to oscillate the applicator 131 between an initial applicator position 131a, a secondary applicator position 131b, and a tertiary applicator position 131c, thereby enabling the applicator 131 to continuously change position during operation, and thus apply the high-pressure fluid to the entirety of the work surface 101. In at least one embodiment of the present invention, such as the one depicted in FIG. 4, the oscillation assembly 120 may be configured to oscillate the applicator 131 in a directed transverse to the direction the head assembly 100 is moving. However, alternative embodiments of such an oscillation assembly 120 are envisioned herein, such as one wherein the oscillation assembly 120 is configured to oscillate the applicator in alternative directions or, instead, rotate the applicator about an axis of rotation.

Specifically, the oscillation assembly 120 in accordance with at least one embodiment of the present invention may comprise an upper track 121 and a lower track 122. Such upper track 121 and such lower track 122 may be integrally formed into either, or both, the upper chassis 111 and the lower chassis 112 of the chassis assembly 110, or may alternatively comprise components distinct therefrom. Each of the upper track 121 and the lower track 122 may comprise, for instance, pins, rails, or any other like structure upon which a component may be disposed and configured for movement there along.

Specifically, such upper track 121 and lower track 122 may be cooperatively configured to allow for the oscillatory motion of the applicator 131. For instance, such lower track 122 may be configured for operative engagement with the applicator 131, which may be disposed on and/or about the lower track 122. Accordingly, such applicator 131 may be configured to move longitudinally along such lower track 122, thereby enabling such applicator 131 to oscillate between the initial applicator position 131a, the secondary applicator position 131b, and the tertiary applicator position 131c.

In conjunction therewith, such upper track 121 may be configured for operative engagement with a drive mechanism 123. More specifically, such drive mechanism 123 may be disposed on and/or about such upper track 121, and may be configured to move longitudinally along such upper track 121. Alternatively, it may be understood such drive mechanism 123 may instead be configured to move an alternative component about such upper track 121. Such a drive mechanism 123 may comprise, for instance, a drive motor or any other like component configured to provide such movement along the upper track 121. Disposed in connection with such drive mechanism 123 may be an attachment apparatus 124 which may be attached to such applicator 131. Accordingly, it may be understood any movement provided by the drive mechanism 123 may be imparted onto the applicator 131 through the drive arm 124. As such, the applicator 131 may move along such lower track 122 due to the movement provided by the drive mechanism 123.

Yet additional embodiments of the head assembly 100 of the present invention may comprise further components configured to assist in the operation of same. For instance, the head assembly 100 of at least one embodiment of the present invention may further comprise a sensor assembly 150 configured to detect and analyze various data pertaining to the operation of the head assembly 100. For instance, such sensor assembly 150 may be configured to detect the distance between the head assembly 100 and various obstacles present on the work surface 101, such as the topography itself or other obstructions, barriers, or impediments which may prevent the head assembly 100 from traversing the work surface 101. Alternatively, such sensor assembly 150 may instead, or additionally, be configured to detect a variety of other data, such as those pertaining to physical properties, such as temperature, pressure or radiation, physical presences, such as flames, metals, or the presence of gases or chemicals, or any other chemo-electromechanical presences deemed appropriate for use in connection with a head assembly.

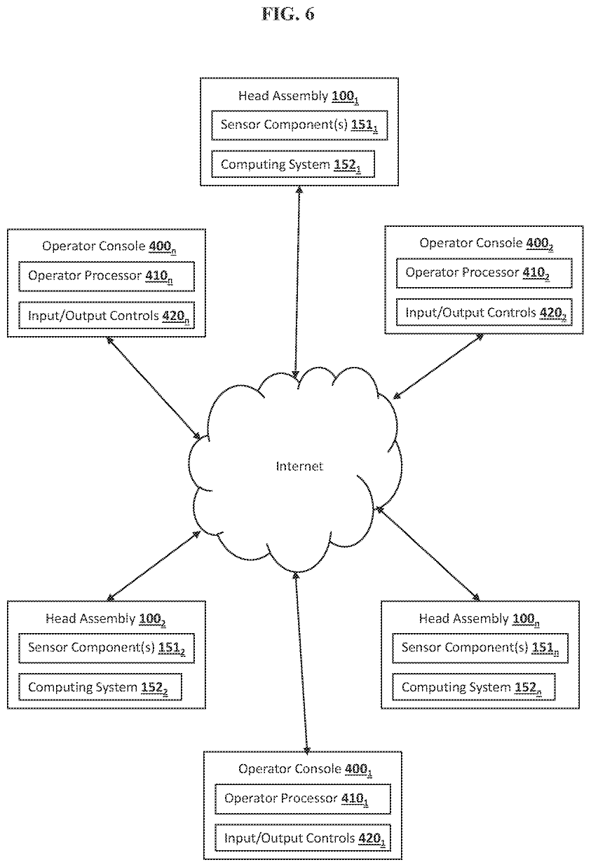

For instance, the sensor assembly 150 of at least one embodiment of the present invention may, as depicted in FIG. 6, comprise at least one, and in some instances a plurality of sensor component(s) 151 configured to provide such sensing functionality to the head assembly 100. Such sensor component(s) 151 may comprise, for instance, distance sensors, vision and imaging sensors, temperature sensors, radiation sensors, pressure sensors, position sensors, motion sensors, gas and chemical sensors, photoelectric sensors, metal sensors, leak sensors, or any other sensor now known or hereafter developed. Such sensor component(s) 151 may additionally comprise at least one transducer configured to monitor the vital signals of the system, thereby ensuring such head assembly remains in proper condition throughout the operation thereof.

As further depicted in FIG. 6, a sensor assembly 150 in accordance with at least one embodiment of the present invention may additionally comprise an electrical computing system 152 configured to collect the data gathered by the sensor component(s) 151, convert such data in binary code, and transmit such binary code to a processor, such as a computer. Accordingly, it may be understood such sensor assembly 150 may be configured to collect any pertinent information from such sensor component(s) 151 and transmit such information, whether through an internet protocol suite, TCP/IP, or otherwise, to an operator of the head assembly 150, thereby enabling such operator to see a variety of information pertaining to the operation of the same. Likewise, it may be understood such sensor assembly 150 may instead be configured to enable the remote and/or autonomous operation of the head assembly 100 through such interaction between the sensor component(s) 151 and the electrical computing system 152.

Accordingly, it may be understood such electrical computing system 152 may be configured to transmit information and/or data to distinct operator consoles 400, or, alternatively, to other head assemblies 100. As such, it may be understood such sensor component(s) 151 may thus be disposed in connection with at least one operator console 400 through the internet or some other connection over a peer-to-peer network. Such at least one operator console 400 may likewise have an operator processor 410, which may itself comprise a memory having computer-readable instructions disposed thereon. Moreover, such operator processor may have a graphic user interface having input/output buttons 420 disposed thereon, wherein such input/output buttons 420 may be configured to interact with the information provided by the sensor component(s) 151. For instance, such input/output buttons 420 may be configured such that a user of such operator console 400 may selectively view certain data associated with at least one of such sensor component(s) 151. Even further, in at least one embodiment of the present invention, such input/output buttons 420 may be configured to control at least a portion of the head assembly 100 through the electrical computing system 152. For instance, such input/output buttons 420 may be configured to control the pressure of the fluid applied by the head assembly, thereby enabling an operator to selectively control the amount of pressure applied to a given work surface 101. In so doing, it may be understood such operator may thus operatively switch between various modes of hydroblasting activity, such as cleaning and destruction, or alternatively, apply a different level of pressure for a work surface comprised of different materials.

Even further, as also depicted in FIG. 6, such head assembly 100 may be communicatively configured in connection with other head assemblies 100₂-100ₙ. In so doing, it may be understood the sensor components 151₁ of the head assembly 100₁ may therefore communicate with the remaining head assemblies 100₂-100ₙ, and the components thereof, via the head processor 152₁. As such, it may be understood such head assemblies 100₁-100ₙ may therefore operate in conjunction with each other, thereby reducing or even vitiating instances of interference and/or collisions therebetween. Likewise, in so doing, it may be understood any operations dictated to one head assembly 100₁ by an operator console 400₁-400ₙ may, in at least one embodiment of the present invention, be imparted onto the remaining head assemblies 100₂-100ₙ. In so doing, operator work may be reduced, and the efficiency of the fleet of head assemblies 100₁-100ₙ may thus be increased.

As previously stated, alternative embodiments of the head assembly 100 of the present invention may be disposed in connection with at least one type of conveyance 200. For instance, the rotatable coupling 119 may be configured to provide removable engagement with a plurality of conveyances 200. However, it may be understood various conveyances 200 may have various types of connections, or otherwise be disposed for use with a mounting assembly 140 disposed between such conveyance 200 and such rotatable coupling 119. Accordingly, it may be understood at least some embodiments of the conveyances 200 envisioned herein may be configured for use with such a mounting assembly 140.

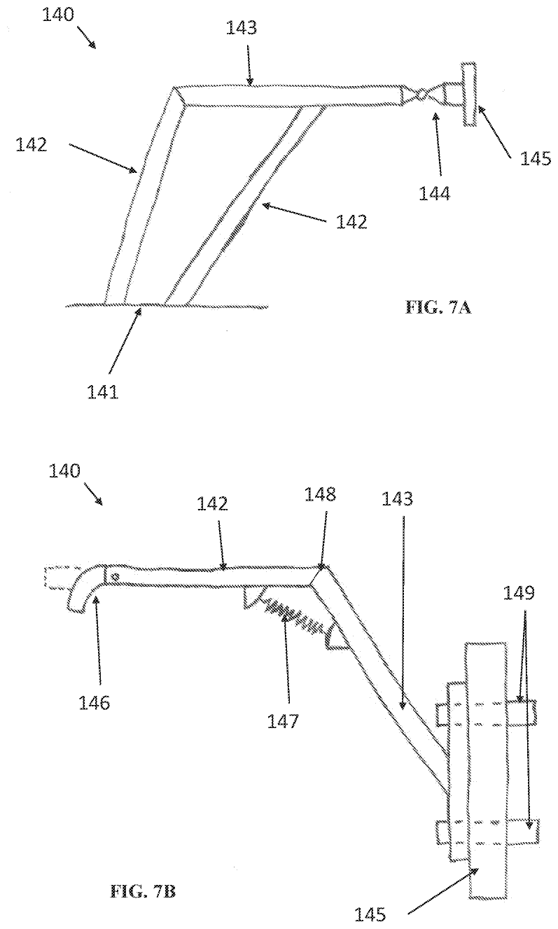

Alternative embodiments of such a mounting assembly 140 may be seen with reference to FIGS. 7A-7B. For instance, one such mounting assembly 140 may be seen in FIG. 7A, wherein such a mounting assembly 140 may comprise a conveyance plate 141, for attachment to a conveyance 200. Such conveyance plate 141 may be disposed in connection with at least one, and in some instances a plurality of, brace arm(s) 142. As may be understood, such conveyance plate 141 may be configured for attachment with any type of conveyance, such as through a variety of fasteners or otherwise. Such brace arm(s) 142 may further be disposed in connection with an attachment arm 143, upon which the head assembly 100 may be attached. As may be understood such brace arm(s) 142 and attachment arm 143 may comprise a beam, rod, bar, or any other like structure configured to provide structure, support, and/or relative moment to, and between, the conveyance 200 and the head assembly 100. Attached to such attachment arm 143 may be a mounting plate 145, upon which the head assembly 100 may be attached, such as through the rotatable coupling 119. Further, disposed between such mounting plate 145 and the attachment arm 143 may be a swivel mount 144 configured to enable the mounting plate 145 to rotate in at least one degree of freedom relative to the attachment arm 143.

An alternative embodiment of such a mounting assembly 140 may be seen in FIG. 7B. There, it may be seen such a mounting assembly 140 may comprise a brace arm 142 disposed in connection with an attachment arm 143 through a junction component 148, such as a hinge or flexible joint, configured to enable the attachment arm 143 to move relative to the brace arm 142. Such brace arm 142 may be attached to a connector 146, which may itself be attached to a conveyance 200. Such connector 146 may be configured, in at least one embodiment of the present invention, to rotate amongst a variety of angles, such as through a pin structure, as depicted by the dashed lines in FIG. 7B. Further, disposed in connection with both the brace arm 142 and the attachment arm 143 may be a mounting biasing member 147, which may be configured to provide support to the attachment arm 143 when the same is rotated about the junction component 148. As before, attached to such attachment arm 143 may be a mounting plate 145, which may include fasteners 149 configured for attachment of the mounting plate 145 to a head assembly 100, whether through a rotatable coupling 119 or otherwise.

As previously discussed, alternative embodiments of the head assembly 100 of the present invention may be disposed in connection with alternative types of conveyances 200. More specifically, the rotatable coupling 119 attached to the upper chassis 111 of the head assembly 100 may be disposed in operative engagement with any given conveyance 200, whether through an attachment arm or other like apparatus, or through some other means attached thereto. As may be understood, such rotatable coupling 119 may be configured for operative engagement with numerous types of conveyances 200, each of which may be preferable dependent upon the type of work surface 101 to be treated by such head assembly 100. Accordingly, in at least one embodiment of the present invention, such rotatable coupling 119 may be configured for removable engagement with any conveyance 200, or alternatively any component of which such conveyance 200 is comprised, such that the rotatable coupling 119, and by extension the head assembly 100 as a whole, may be removed from one such conveyance 200 and subsequently attached to another, thereby enabling an operator thereof to selectively apply such head assembly 100 to a conveyance 200 appropriate for the task at hand.

In accordance therewith, it may be understood various embodiments of the present invention may comprise a variety of different conveyances 200. For instance, alternative embodiments of the conveyance of the present invention may comprise a man lift, a track hoe, a scissor lift, a boom, a scaffolding or some other frame and/or track system, a wheel cart, or any other conveyance 200 whether now known or hereafter developed. As previously discussed, such conveyances 200, their interaction with the head assembly 100, and their application to a given work surface 101 are merely exemplary, as myriad conveyances 200 and applications thereof are envisioned herein. Likewise, it may be understood at least certain components of the present invention, such as the pneumatic assembly 300 discussed heretofore and hereafter may also be used in connection with myriad conveyances 200, whether explicitly recited herein or otherwise.

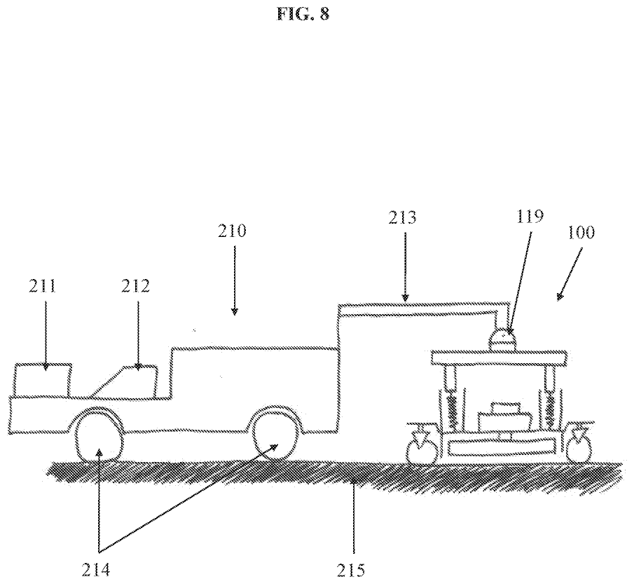

For instance, as depicted in FIG. 8, one embodiment of the conveyance 200 of the present invention may comprise a truck 210. As may be understood, such truck 210 may have a truck arm 213, such as a beam or rod extending therefrom, or alternatively the aforementioned mounting assembly 140, wherein such truck arm 213 may be operatively engaged with the rotatable coupling 119 of the head assembly 100. Accordingly, it may be understood such operative engagement between the truck arm 213 and the rotatable coupling 119 may enable such truck 210 to move such head assembly 100, via the wheels 214 or other like truck mobility components, about the work surface 101, which may itself comprise a floor, whether having a flat or irregular topography.

As further depicted in FIG. 8 such truck 210 may comprise yet additional components. For instance, at least one embodiment of such truck 210 may comprise a vacuum component 211 configured to collect any particles and/or debris dislodged by the head assembly 100. For instance, such vacuum component 211 may be disposed such that it collects any such particles and/or debris which pass underneath such truck, thereby enabling the truck 210 to automatically collect such particles and/or debris as it follows the path of the head assembly 100 on the work surface 101. Alternatively, such vacuum component 211 may be interconnected with the vacuum lines 131b of the head assembly 100 and/or applicator 131. Even further, it may be understood at least one embodiment of such truck 210 may further comprise a fluid tank 212, which may be configured to feed the hydroblasting fluid to the head assembly 100 at a high pressure, whether through connecting lines or otherwise.

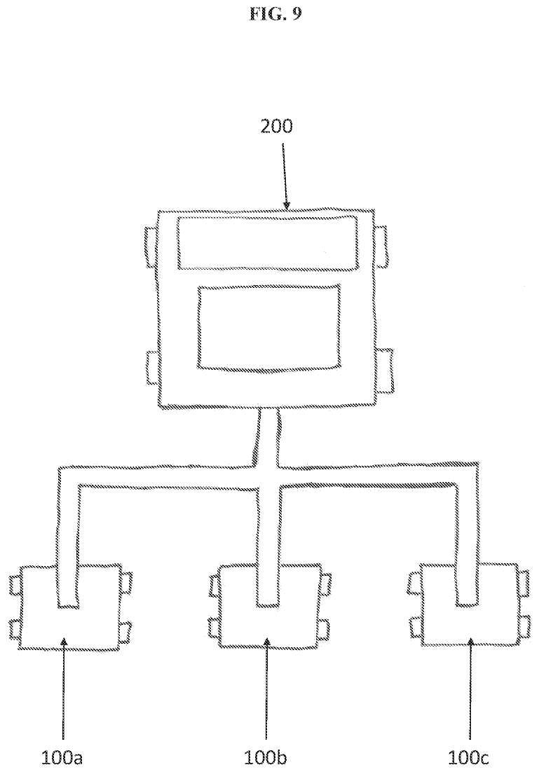

Even further, it may be understood such a truck 210 may be further configured for the operation of at least two, and in some instances a plurality of, head assembly 100. For instance, FIG. 9 depicts an embodiment wherein one truck 210 is configured for use with three independent head assemblies 100. As may be seen, in such an embodiment, the truck 213 may be configured to be attached to the rotatable coupling 119 of each of such three independent head assemblies 100, thereby enabling such truck 210 to move all three head assemblies 100 at one time. Accordingly, such an embodiment may thus enable a single operator to affect an even greater surface area of the pertinent work surface 101 through a single conveyance 200.

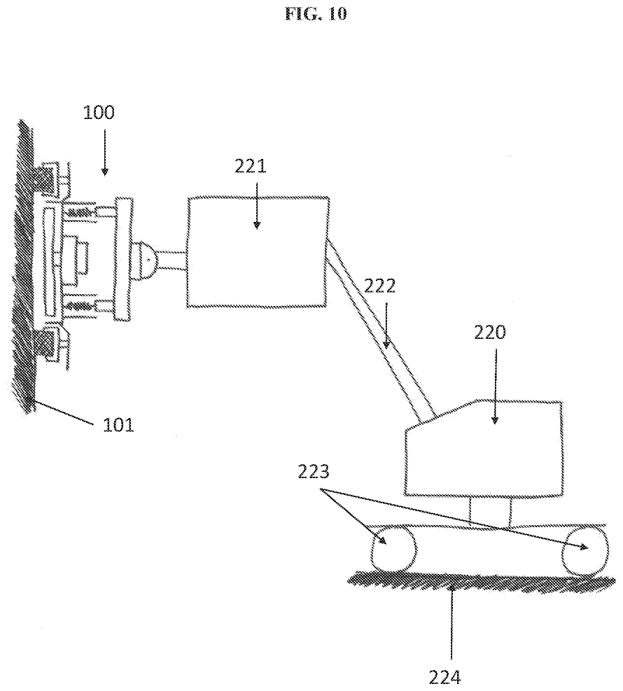

In an additional embodiment of the present invention, such as the one depicted in FIG. 10, the head assembly 100 may instead be configured to be applied to a work surface 101 comprising a wall. Accordingly, such an embodiment of the present invention may instead comprise a conveyance 200 comprising a man lift 220 disposed in connection with such a head assembly 101. Such a man lift 220 may be attached directly to the head assembly 100 via the rotatable coupling 119 disposed thereon, or instead may be attached thereto via an intervening connection, such as the aforementioned mounting assembly 140, disposed there between. Such a man lift 220 may, in various embodiments, include a man basket 221 attached to said man lift 220 via a man lift arm 222.

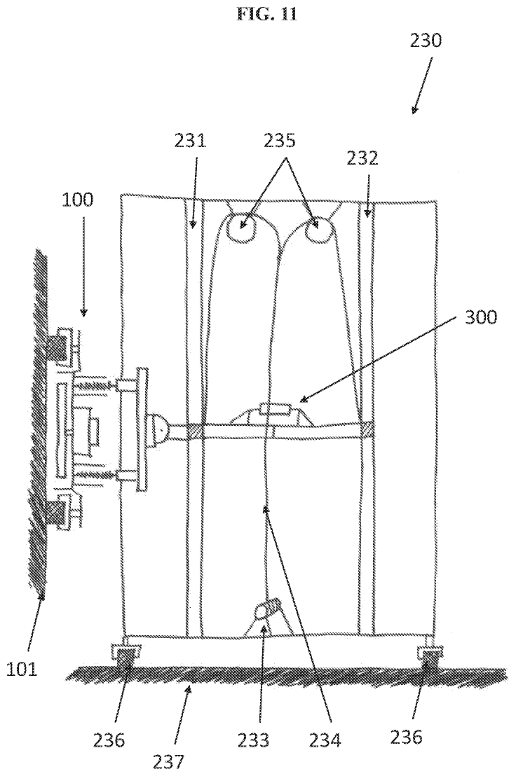

An additional embodiment of the present invention configured to apply the head assembly 100 to a work surface 101 comprising a wall may be seen with reference to FIG. 11. As may be seen, such a conveyance 200 may comprise a scaffold assembly 230, wherein such scaffold assembly 230 may be configured to traverse about a floor surface, via wheels 236, which may themselves be disposed as part of a wheel-and-track system. Such scaffold assembly 230 may further be configured to enable such head assembly 100 to be moved in a vertical manner about the work surface 101. More specifically, such scaffold assembly 230 may comprise a cable assembly comprising a winch 233 disposed in connection with cable(s) 234 and a pulley system 235. Such cable assembly may be configured in connection with a cable arm 238 upon which the head assembly 100 is attached, wherein such attachment arm is slidably engaged between a guide bar 231 and a backing bar 232. Thus, it may be understood any movement provided by the cable assembly via the winch 233 will be imparted upon the cable(s) 234, and onto the cable arm 238, thus providing vertical movement to the head assembly 100, wherein the load imparted on the cable(s) 234 may be effectively reduced by the pulley system 235.

With continued reference to FIG. 11, it may be seen the cable arm 238 of such a scaffold assembly 230 may, in at least one embodiment, have a pneumatic assembly 300 disposed therein and/or connected therewith. Such a pneumatic assembly 300 may be configured to apply a certain amount of force to the head assembly 100 attached thereto, thereby enabling such head assembly 100 to remain in constant and/or sufficient contact with the work surface 101 throughout the operation thereof.

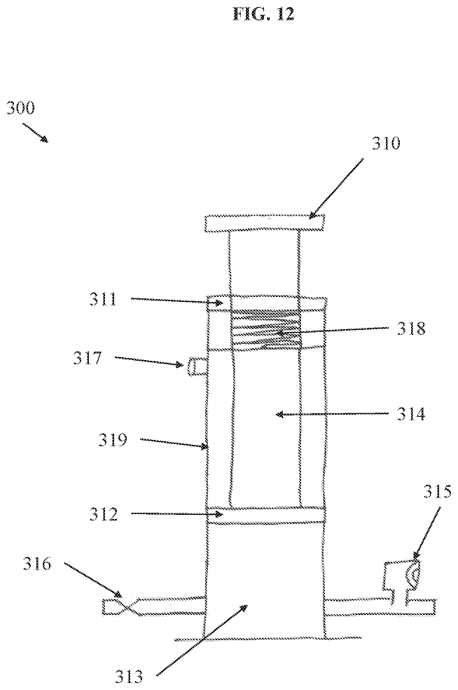

An exemplary embodiment of such a pneumatic assembly 300 may be seen in FIG. 12. As depicted therein, such a pneumatic assembly 300 may comprise a housing having an outer seal 311 and an inner seal 312. Such inner seal 312 and such housing may be configured to create an air chamber 313 at one end of the pneumatic assembly 300. Formed between such outer seal 311 and inner seal 312 may be a piston chamber 319, wherein such piston chamber 319 may house a piston 314. Such piston 314 may be attached to the inner seal 312 and may extend beyond such outer seal 311 for connection with a moveable plate 310. In certain embodiments, such moveable plate 310 may be attached to an attachment arm, moveable beam, or some other component of a given conveyance, or, conversely, to the head assembly 100 itself. Further, disposed in connection with such piston 314 may be a pneumatic biasing element 318, which may be predisposed to apply force to such piston 314 in at least one direction, thereby driving such piston 314 towards an initial pneumatic orientation.

As further depicted in FIG. 12, at least one embodiment of such a pneumatic assembly 300 may further comprise various components configured to control the air flow both into, and out of, the same. More specifically, such a pneumatic assembly 300 may further comprise an air inlet 315 and an air outlet 316, each of which may be disposed in connection with the air chamber 313, thereby enabling air or some other gaseous medium to flow into and out of the air chamber 313. Such an air inlet 315 may comprise, for instance, an air regulator, whereas such an air outlet 316 may comprise, for instance, a discharge valve, although alternative components are envisioned herein. As may be understood, by controlling the amount of air disposed within the air chamber 313, the pressure disposed within such air chamber 313 may therefore be manipulated. Accordingly, upon the provision of sufficient pressure within the air chamber 313, the force applied to the inner seal thereby may be sufficient to overcome the force applied by the pneumatic biasing member 318, thereby enabling the piston 314 to be driven in at least one direction. In so doing, it may be understood the volume of the piston chamber 319 may likewise be altered. Thus, such piston chamber 319 may have a piston vent 317 disposed in connection therewith, which may allow air to freely flow both into and out of the piston chamber 319, thereby ensuring the pressure of the piston chamber 319 does not fluctuate along with the volume thereof.

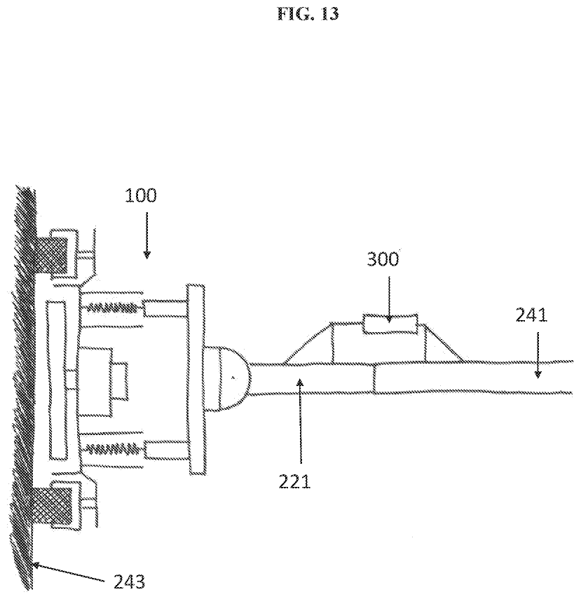

Accordingly, it may be understood the pneumatic assembly 300 of at least one embodiment of the present invention may be configured to longitudinally expand and/or contract dependent upon the amount of air pressure disposed within the air chamber 313. In so doing, it may be understood anything connected to the moveable plate 310 may thus be moved by such pneumatic assembly 300 as well. As such, in an embodiment wherein the head assembly 100 is engaged with such pneumatic assembly 300, such as the embodiment depicted in FIG. 13 whether directly, through an attachment arm disposed there between, or otherwise, it may be understood such pneumatic assembly 300 may be configured to apply a sufficient amount of force to such head assembly 100 to ensure the same remains in operative engagement with the work surface 101. In so doing, it may be understood the pneumatic assembly 300 of at least one embodiment of the present invention may be configured to apply variable amounts of force to the head assembly 100, thereby controlling the level of engagement between such head assembly 100 and the work surface 101.

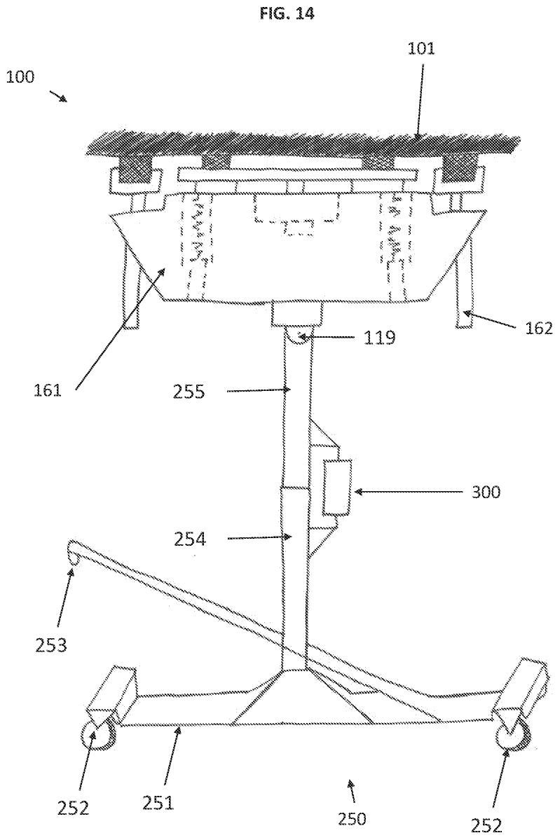

As previously stated, such a pneumatic assembly 300 may be used in various embodiments of the present invention, and particularly those wherein the head assembly 100 is meant to be applied to a work surface 101 comprising a wall, a ceiling, or some other structure wherein gravity may work to impede the head assembly 100 from maintaining sufficient contact with such work surface 101. For instance, one such embodiment utilizing such a pneumatic assembly 300 may be seen with reference to FIG. 14, wherein one embodiment of the head assembly 100 of the present invention may be disposed in connection with a conveyance 200, such as a wheeled cart 250, for application of such head assembly 100 on a work surface 101 comprising a ceiling, wherein such head assembly 100 is disposed in connection with such wheeled cart 250 via a pneumatic assembly 300. Such a wheeled cart 250 may comprise, for instance, a cart base 251 disposed in connection with a plurality of cart wheels 252. Such wheeled cart 250 may be moved, steered, or otherwise controlled via a cart handle 253.

With further reference to FIG. 14, it may be seen the head assembly 100 may be disposed in connection with such pneumatic assembly 300 and such wheeled cart 250 via a stationary cart beam 254 and a moveable cart beam 255. More specifically, such moveable cart beam 255 is disposed in operative engagement with the rotatable coupling 119 of the head assembly 100, while the stationary cart beam 254 is statically disposed in connection with the cart base 251. Operatively disposed in connection with both the stationary cart beam 254 and the moveable cart beam 255 is the pneumatic assembly 300, wherein the moveable plate 310 of the pneumatic assembly 300 may be attached to the moveable cart beam 255. Accordingly, it may be understood the pneumatic assembly 300, by expanding the moveable plate 310 through the aforementioned processes, may be disposed to likewise expand the moveable cart beam 255, thus applying force to the head assembly 100 through the operative engagement of the moveable cart beam 255 with the rotatable coupling 119. As such, the pneumatic assembly 300 may therefore be configured to cause the head assembly 100 to remain operatively engaged with the work surface 101 throughout the operation thereof.

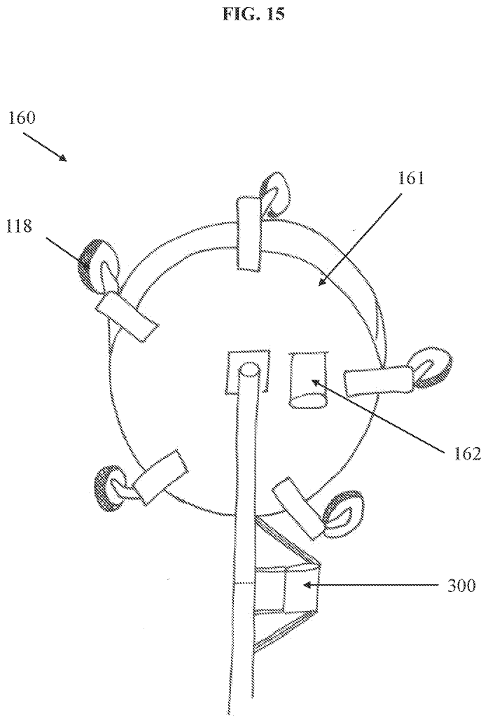

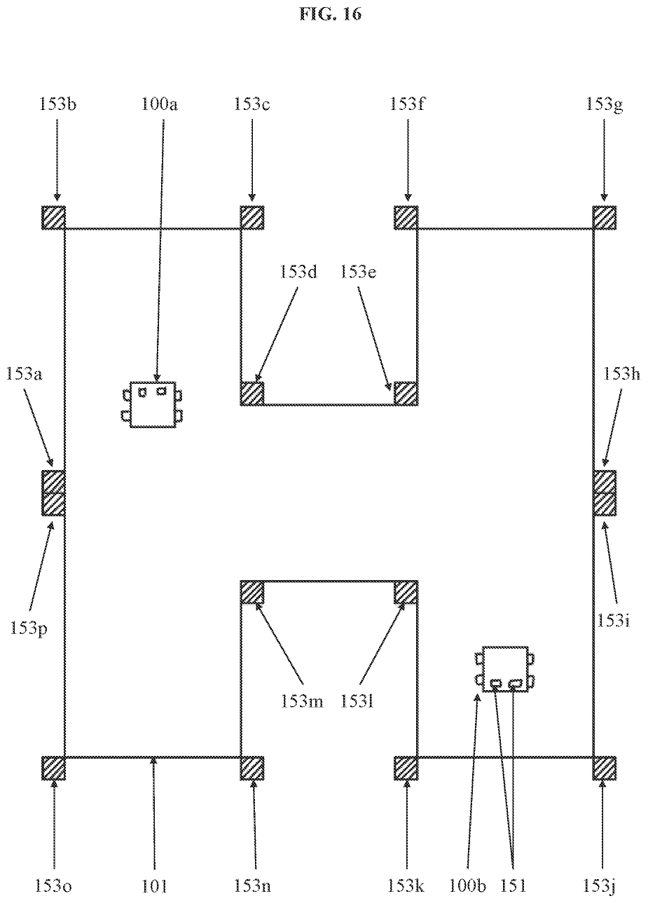

With continued reference to FIG. 14 and additional reference to FIG. 15, it may be seen the head assembly 100 for such an embodiment may comprise yet additional components configured to assist in the hydroblasting operation of the work surface 101 comprising a ceiling. More specifically, such embodiments depict a head assembly 100 configured for use in applications wherein the work surface 101 comprises a ceiling, wherein such head assembly 100 comprises additional components configured to prevent debris from falling off the ceiling and onto the conveyance 200, the operator thereof, and/or the floor. Accordingly, it may be seen such an embodiment of the head assembly 100 may further comprise an enclosure assembly 160 configured to trap any such falling debris and safely remove same from the head assembly. Such an enclosure assembly 160 may comprise, for instance, a funnel structure 161 disposed over and around the head assembly, thereby covering a broader area of work surface than the applicator 131 of the head assembly 100. Accordingly, it may be understood any debris loosened by the applicator 131 during the operation of the head assembly 100 may be ensnared by the funnel structure 161, and collected therein, thereby preventing such debris from falling beyond the head assembly 100.

Even further, such enclosure assembly 160 may additionally comprise vacuum component(s) 162 configured to remove such debris from the head assembly 100. Such vacuum component(s) 162 may comprise, for instance, vacuum lines or any other like component configured to remove such debris from the head assembly 100. As may be understood, such vacuum component(s) 162 may, in at least some embodiments, be disposed in connection with the conveyance 200 with which the head assembly 100 is operatively engaged, such that any debris removed from the head assembly 100 by the vacuum component(s) 162 is transferred from the head assembly 100 and into the conveyance 200, such as into a debris receptacle disposed thereon.

As previously stated, at least one embodiment of the present invention may be configured for the autonomous operation of the head assembly 100 and/or the conveyance 200 disposed in connection therewith. For instance, in an embodiment such as the one depicted in FIG. 17, a sensor assembly 150 may be utilized to collect data from sensor component(s) 151 and use such collected data to control the operation of such head assembly 100 and/or conveyance 200. Accordingly, as depicted in FIG. 17, such an embodiment may further be disposed in connection with at least one, and in some instances a plurality of bounding components 153. Such bounding component(s) 153 may, in at least one embodiment of the present invention, be configured to bound, constrain, or otherwise direct the head assembly 100 and/or conveyance 200 as it moves about a given work surface 101. In other words, such bounding component(s) 153 may be configured in connection with such sensor component(s) 151 such that the sensor component(s) 151 may detect the presence of such bounding component(s) 153, and thereby utilize such bounding component(s) 153 to form the boundary of the work surface intended to be treated by the head assembly 100. In so doing, it may be understood such a head assembly 100 and/or conveyance 200 having sensor component(s) 151 disposed thereon may automatically detect the boundaries of the work surface, and thereby remain within such a bounded work surface area for the treatment thereof.

In at least one embodiment of the present invention, such as the one depicted in FIG. 17, such bounding component(s) 153 may comprise, for instance, a plurality of bounding poles disposed at operative locations around a given work surface 101. Such bounding component(s) 153 may have, for instance, certain components disposed thereon and configured to communicate with the sensor component(s) 151 of the head assembly 100. For instance, one such component may be configured to issue communications when a sensor component(s) 151 is disposed within a certain communicative distance, thereby indicating a distance between the head assembly 100 and a boundary of the work surface 101. Alternatively, such a bounding component(s) 153 may instead be configured to simply enable the sensor component(s) 151 to locate same. For instance, such bounding component(s) 153 may instead comprise a structure configured to enable a sensor component 151, such as an ultrasonic echolocation sensor, to locate such bounding component(s) 153.

Even further, it may be understood the boundary component(s) 153 of at least one embodiment of the present invention may be configured to bound a given head assembly 100 and/or conveyance 200 within a certain portion of a work surface 101. Alternatively put, such boundary component(s) 153 may be configured to define certain zones of a given work surface 101 intended to be treated by a single head assembly 100. In so doing, it may be understood a plurality of head assemblies 100 may treat a work surface 101 at a given time, without the possibility of unintentionally crossing paths, colliding, or otherwise treating an area of the work surface 101 already treated by another head assembly 100.

For instance, as depicted in FIG. 17, such boundary component(s) 153 may be grouped such that: (1) a first head assembly 100a can be configured to treat the boundary of the work surface 101 defined by boundary components 153a-153h; and (2) a second head assembly 100b can be configured to treat the boundary of the work surface 101 defined by boundary components 153i-153p. Alternatively, such boundary component(s) 153 may be grouped such that: (3) the first head assembly 100a is configured to treat the boundary of the work surface 101 defined by the rectangular potion having vertices 153b, 153c, 153n, and 153o, and the triangular portion formed by the vertices 153d, 153e, and 153m; and (4) the second head assembly 100b is configured to treat the boundary of the work surface 101 defined by the rectangular portion having vertices 153f, 153g, 153j, and 153k, and the triangular potion formed by the vertices 153e, 153l, and 153m. Accordingly, it may be understood the boundaries formed by the boundary components 153 may be fully customizable, may be configured to apply abstract boundaries, and may be suitable to form any number of boundaries within a work surface 101 dependent upon the number of boundary components 153 available to a user. In so doing, it may be understood the autonomous nature of the head assembly 100 and/or conveyance 200 of the present invention may be fully customizable, and configurable by a user to obtain greater efficiency levels.

In view of the foregoing, it may be understood various embodiments of the present invention may be configured to resolve some, if not all of the problems currently present in traditional hydroblasting systems. Indeed, certain embodiments of the head assembly 100 are configured to traverse irregular topography and efficiently clean the entirety of a work surface in a single pass. Even further, various head assemblies 100 and hydroblasting systems are configured for use in connection with walls and ceilings, such as through the use of a pneumatic assembly 300. And finally, other various components enable the head assembly 100 to be used in connection with a variety of conveyances 200, to automatically collect debris from various work surfaces 101, and to autonomously operate on a given work surface 101.

Since many modifications, variations, and changes in detail can be made to the described and preferred embodiments of the invention, it is intended all matters in the foregoing description and shown in the accompanying drawings be interpreted as illustrative, exemplary, and non-limiting. For example, any use of the terms “preferably” or “preferred embodiment,” as well as other language akin thereto, is intended to refer to one particular embodiment, and solely one particular embodiment. As such, it may be appreciated other embodiments are possible, envisioned, and considered part of the invention disclosed herein. Thus, the scope of the invention should be determined by the appended claims and their legal equivalents.

What is claimed is:

1. A hydroblasting system comprising:
a hydroblasting head assembly mounted to a conveyance, said conveyance having a drive system capable of receiving electrical signals as inputs;
a computerized control system disposed in communication with said drive system, said computerized control system being further operative to generate control instructions and transmit said control instructions to said drive system, said computer control instructions being operative to move said head assembly relative to a work surface.

2. The hydroblasting system of claim 1 further comprising wherein said control instructions match predetermined inputs of said drive system.

3. The hydroblasting system of claim 1 wherein said computerized control system is further configured to reference a three-dimensional model of said work surface.

4. The hydroblasting system of claim 1 wherein said computerized control system is further configured to receive a predetermined path for said hydroblasting head assembly.

5. The hydroblasting system of claim 4 wherein said computerized control system is further configured to generate and execute control instructions operative to move said hydroblasting head assembly through said predetermined path.

6. The hydroblasting system of claim 1 further comprising a plurality of sensors on said hydroblasting head assembly configured to determine proximity of said head assembly to said work surface.

7. The hydroblasting system of claim 1 further comprising a plurality of boundary control elements disposed about said work surface.

8. The hydroblasting system of claim 1 wherein said conveyance is selected from the group consisting of: a man lift, a track hoe, a scissor lift, a boom, a scaffolding system, and a wheeled cart.

9. The hydroblasting system of claim 1 wherein said head assembly further comprises an upper chassis and a lower chassis with at least one biasing member disposed there between; said lower chassis having an applicator disposed there below; said lower chassis having at least one mobility component disposed thereon; and said applicator disposed in fluid communication with a pump component through at least one manifold.

10. The hydroblasting system of claim 9 wherein said manifold further comprises an oscillation assembly configured to shift said applicator between at least a first position and a second position.

11. The hydroblasting system of claim 1 wherein said work surface includes a vertical surface.

12. The hydroblasting system of claim 1 wherein said work surface includes a ceiling.

13. A method for autonomous hydroblasting comprising:
providing a hydroblasting head assembly mounted to a conveyance, the conveyance having a drive system capable of receiving electrical signals as inputs;
further providing a computerized control system disposed in communication with the drive system, the computerized control system being further operative to generate control instructions and transmit the control instructions to the drive system, the computer control instructions being operative to cause the conveyance to move the head assembly relative to a work surface;
obtaining a three-dimensional model of a work surface to be hydroblasted;
utilizing the three-dimensional model of the work surface to generate pathways along the work surface which the hydroblasting head assembly will follow during a hydroblasting procedure;
transmitting the pathways to the computerized control system as machine instructions;
executing the machine instructions on the computerized control system.

14. The method as recited in claim 13 wherein the conveyance is selected from the group consisting of: a man lift, a track hoe, a scissor lift, a boom, a scaffolding system, and a wheeled cart.

15. The method as recited in claim 13 further comprising the step of permitting the computerized control system to move the hydroblasting head along the generated pathways in an autonomous fashion.

16. The method as recited in claim 13 wherein the control instructions match predetermined inputs of the drive system.

17. The method as recited in claim 13 wherein the hydroblasting head assembly comprises at least an upper chassis and a lower chassis with at least one biasing member disposed therebetween.

18. The method is recited in claim 13 wherein the work surface includes a vertical surface.

19. The method as recited in claim 13 wherein the work surface includes a ceiling.

20. The method as recited in claim 13 wherein the hydroblasting head assembly further comprises an oscillating assembly configured to shift an applicator between at least a first position and a second position.
